(19) United States
(12) Patent Application Publication
(10) Pub. No.: US 2015/0295959 A1
(43) Pub. Date: Oct. 15, 2015

(54) AUGMENTED REALITY TAG CLIPPER

(71) Applicant: HEWLETT-PACKARD DEVELOPMENT COMPANY, L.P., Houston, TX (US)

(72) Inventors: SEUNGYON LEE, Sunnyvale, CA (US); FENG TANG, Palo Alto, CA (US)

(21) Appl. No.: 14/438,209

(22) PCT Filed: Oct. 23, 2012
(86) PCT No.: PCT/US2012/061490

§ 371 Date: Apr. 23, 2015

(51) Int. Cl. H04L 29/06; G06T 19/00; G06K 9/46; H04L 29/08

(52) U.S. Cl. CPC H04L 65/403; H04L 67/1097; G06T 19/006; G06K 9/4604

(57) ABSTRACT

A computing device, comprising a virtual content cupping module which, with a processor, cups an amount of virtual content from virtual content received by the computing device. An augmented reality tag clipper system, comprising a computing device comprising a processor and a data storage device, an image server communicatively coupled to the computing device, and a repository server communicatively coupled to the computing device and image server, in which the computing device comprises a virtual content clipping module which receives virtual content associated with an object in a digital image, receives instructions to clip the virtual content, and causes the clipped virtual content to be sent to the repository server. A method of clipping virtual content comprising, with a processor, receiving virtual content from an image server on a computing device clipping an amount of virtual content from the virtual content, and sending clipped virtual content to a repository server.

### BACKGROUND

Augmented reality is the use of computer generated sensory input to augment live real-world environments. Through augmented reality, a user is given access to information about the world around them via a graphical user interface and a computing device. In one example, a user may access this information through a mobile device which uses a camera to view objects in the real-world environment. Real-world objects that have virtual content associated with them may have that virtual content overlaid on the graphical user interface for a user to view.

### BRIEF DESCRIPTION OF THE DRAWINGS

The accompanying drawings illustrate various examples of the principles described herein and are a part of the specification. The examples do not limit the scope of the claims.

FIG. 1 is a block diagram of an augmented reality tag clipper system according to one example of principles described herein.

FIG. 2 is a block diagram of an augmented reality tag clipper system according to another example of principles described herein.

FIG. 3 is a block diagram of an augmented reality tag clipper system according to another example of principles described herein.

FIG. 4 is a flowchart showing a method of clipping virtual content according to one example of principles described herein.

Throughout the drawings, identical reference numbers designate similar, but not necessarily identical elements.

### DETAILED DESCRIPTION

As described above, a user is able to access, via a computing device, various types of information provided in virtual content using augmented reality. Consuming the richness of the virtual content, however, depends on physical triggers that lock the consumption experience within designated physical locations. Even when virtual content is accessed by a user, the user is limited as to what he or she can do with that information if, for example, the user was to be given a phone number or address as part of the virtual content accompanying the physical trigger. In order for the user to, for example, call that number or receive directions to that address, he or she may have to write the information down before leaving the augmented reality environment and accessing his or her personal phone book or address book on the computing device. Still further, for similar reasons, the user may be left with the inability to conveniently share the virtual content with others. The present specification therefore describes a system that allows a user to clip from the virtual content portions of that virtual content. The virtual content may be saved, shared immediately from the augmented reality environment, or shared later from a user accessible storage device.

Further to the above, a publisher of virtual content is not provided with a method of determining specifics about the virtual content their customers are viewing. For example, a publisher, such as a corporation, may wish to know what demographics of people are interested most in their virtual content. Acquisition of this information may provide the publisher with the ability to focus advertising or selling efforts in a specific location to a specific gender, race, or age of a person. However, once the publisher has uploaded the virtual content to, for example, a server, the publisher is not provided any information as to what content is being accessed and how it is being used. The system described herein also provides a publisher with specifics regarding the virtual content they have uploaded such as who is accessing the virtual content and what they are doing with the content.

In one example, the present application, describes a computing device, comprising a virtual content clipping module that, with a processor, clips an amount of virtual content from virtual content received by the computing device. The present application further describes an augmented reality tag clipper system, comprising a computing device comprising a processor and a data storage device, an image server communicatively coupled to the computing device, and a repository server communicatively coupled to the computing device and image server, in which the computing device comprises a virtual content clipping module which receives virtual content associated with an object in a digital image, receives instructions to clip the virtual content, and causes the clipped virtual content to be sent to the repository server. Still further, the present application described a method of clipping virtual content comprising, with a processor, receiving virtual content from an image server on a computing device clipping an amount of virtual content from the virtual content, and sending clipped virtual content to a repository server.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “virtual content” is meant to be understood broadly as any information associated with an object captured in an image. The object captured in an image may be determined by an image recognizer upon which the image recognizer may provide virtual content about the object to a user. This virtual content may be at least viewed by the user on, for example, a computing device. In one example of the present specification, the virtual content associated with the object within the image may be both viewed and clipped by the user for later use by the user. This example will be described in more detail below.

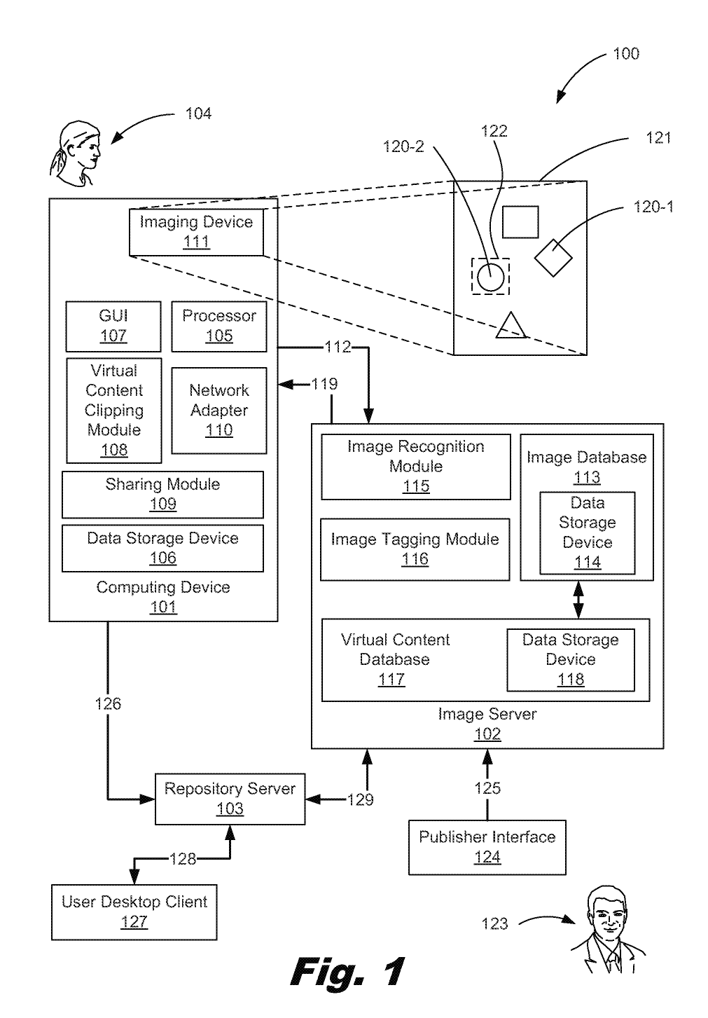

FIG. 1 is a block diagram of an augmented reality tag clipper system (100) according to one example of principles described herein. The system (100) may comprise generally a computing device (101) communicatively coupled to an image server (102) and both of which are communicatively coupled to a repository server (103). Each of these will now be described in more detail.

The computing device (101) may be any computing device comprising a processor (105). The processor (105) may receive computer program instructions, interpret those instructions, and execute those instructions to accomplish at least the functions of the system (100) described below. The computing device (101) may be any type of computing device which comprises the hardware and computer readable program code to accomplish at least the functions of the system (100) described below. Therefore, the computing device (101) may comprise, for example, a desktop computer, a laptop computer, a personal digital assistant (FDA), a tablet computer, a mobile device, and a smartphone, among others. In various examples of the present application, the computing device (101) may be described in terms of being a smartphone device for ease of description. However, this language is not meant to limit the specification at all and the present application instead contemplates the use of any of the above types of computing devices (101).

The computing device (101) may further include a data storage device (106) to store computer readable program code on the computing device (101). The data storage device (106) may include, for example, Random Access Memory (RAM), Read Only Memory (ROM), Hard Disk Drive (HDD) memory, and flash memory. Many other types of data storage devices (106) are available, and the present specification contemplates the use of any type of data storage device (106) as may suit a particular application of the principles described herein, In certain examples, different types of memory in the data storage device (106) may be used for different data storage needs. In certain examples the processor (105) may boot from ROM, maintain nonvolatile storage in the HDD memory or flash memory, and execute program code cached in RAM.

The computing device further includes a graphical user interface (GUI) (107), The GUI (107) may allow a user (104) to interact with the hardware and programming code located on the computing device (101). In the example where the computing device (101) is a smartphone, the GUI may be a touch screen which allows a user (104) to access a number of applications on the phone. In this example, the applications may include a virtual content clipping module (108) and a sharing module (109), both of which will be described in more detail below. These applications and modules (108, 109) may, when executed by the processor (105), allow a user (104) to view virtual content in an augmented reality environment, clip objects from the virtual content being viewed, and share those objects to others.

A network adapter (110) included with the computing device (101) may provide communication between the computing device (101) the image server (102) and the repository server (103). As will be described below, the network adapter (110) may provide the computing device with the ability to request and receive virtual content in an augmented reality environment. Additionally, the network adapter (110) may provide the computing device (101) with the ability to send clipped virtual content objects to the repository server (103). The network adapter may facilitate a wired or wireless communication. Again, in the example above where the computing device (101) is a smartphone, the network adapter (110) may facilitate the actions described above using a wireless internet connection. Alternatively, the network adapter (110) may facilitate the actions described above using a cellular network connection. Still further, the network adapter (110) may facilitate the actions described above using a number of other connection methods both wired and wireless such as a LAN line connection, an optical fiber line connection, a Bluetooth connection, and an Ethernet connection, among others.

The computing device (101) also includes an imaging device (111). The imaging device (111) may be any type of imaging device capable of providing a digital image to the computing device (101). In one example the imaging device (111) may be a camera on a smartphone or other mobile device. In this example, the camera provides a digital image to the computing device (101) and the computing device (101) analyzes the image using the processor to extract features of the image. In one example, the computing device may use image features such as Structured Binary Intensity Patterns (sBIP) to extract the features of the image.

In the example where the imaging device (111) is a camera on a smartphone, the camera may take a digital image of a particular scene (121). A scene (121) may comprise a number of objects (120-1, 120-2). When attempting to acquire virtual content associated with an object being captured in an image, a user (104) may intentionally or unintentionally capture multiple objects (121-1, 121-2) within the scene (121). Each of these objects (120-1, 120-2) may or may not have virtual content associated with them. In one example, the virtual content may be stored on a database (117) in the image server (102). In another example, the virtual content may be stored on a database (117) of another server separate but communicatively accessible to the image server (102).

The data defining the features in the image (112) are sent to the image server (102) to be matched up with images stored on the data storage device (114) the image database (113). In order to match up the data defining the features in the image (112) with an image on the image database (113) the image server (102) may comprise an image recognition module (115). The image recognition module (115) may receive the data defining the features in the image (112), search the image database (113), and match up the images. In some cases, the data defining the features in the image (112) may not be matched up with data on the image database (113) because of a number of reasons. Physical limitations of the computing device's (101) imaging device (111) could cause the data defining the features in the image (112) to be unverifiable. Also, counterpart data in the image database (113) may not exists to match up with the data defining the features in the image (112). When this occurs, a notification may be returned to the computing device (101) which indicates that no augmented reality virtual content has been provided for the subject matter within the captured image.

If, however, the counterpart data does exist on the image database (113) that corresponds to the data defining the features in the image (112), an image tagging module (116) may be employed to deliver virtual content about the subject matter of the image to the computing device (101). Specifically, the image tagging module (116) may find data stored on a data storage device (118) of a virtual content database (117) that is paired up with the image found in the image database (113) that matched the data defining the features in the image (112). When the virtual content is found, the image tagging module (116) may send the virtual content (119) to the computing device (101).

The virtual content (119) may be any type of content including, but not limited to video files, audio files, text files, and data files defining how haptic feedback devices on the computing device (101) should react. The virtual content (119) may be provided to the virtual content database (117) by a publisher (123) using a publisher interface (124). Therefore, prior to a user (104) attempting to gain access to virtual content (119) associated with an object (120-2); the publisher (123) may send a virtual package (125) to the image server (102) and cause that virtual package (125) to be stored on the image server (102). The virtual package (125) may include virtual content (119) as well as images associated with that virtual content (119) to be stored on the image database (113). The publisher (123), using the publisher interface (124), may further cause the image server (102) to associate the image (112) with the virtual content (119). This may be done such that when the image server (102) receives data defining the features in the image (112), the image server (102) may recognize the data defining the features in the image (112) and match that data with the virtual content (119) provided by the publisher (123).

When the computing device (101) receives the virtual content (119) it may display the virtual content on the GUI (107) for a user (104) to view, In one example, the GUI (107) may replace a portion of the scene (121) with the virtual content (119). This portion may be referred to a hotspot (122). In one example, the imaging device (111) may capture a still image of the scene (121). In this example, the still image of the scene (121) may be presented on the GUI (107) and the hotspot (122) may be overlaid with the virtual content (119). Further, in this example, the hotspot (122) may comprise the complete scene (121) or a portion of the scene (121).

In another example, the imaging device (111) may present a real-time image in the form of a video signal on the GUI (107) while the data defining the features in the image (112) are delivered to the image server (102) and processed as described above. The area around the object (120-2) for which virtual content (119) exists, may have that virtual content (119) laid over it. To the user (104) operating the computing device (101), this is viewed as a seamless method in which the virtual content (119) appears to automatically overlay itself on top of the object being viewed on the GUI (107) in real-time.

Once the virtual content (119) has been received by the computing device (101) and has been viewed by the user (104) on the GUI (107), the user may clip some or all of the virtual content (119) using the content clipping module (108). To provide this functionality, the computing device (101) may comprise a number of hard keys or soft keys which, when actuated, allow the user to select and clip an amount the virtual content (119). The amount of clipped virtual content (126) may comprise all or a portion of the virtual content received by the computing device (101). Once the user has selected and clipped the virtual content (119), the user may choose to complete a number of actions.

In one example, the user may choose to send the clipped virtual content (126) to the repository server (103). This may be done so that the user (104) may access the clipped data at a later time using either the computing device (101) or a user desktop client (127). As mentioned previously, virtual content is accessed by the computing device (101) using the imaging device (111). If, for example, the object to which the virtual content (119) was associated with is not accessible by the user (104) at a later time, the repository server (103) saves this information until the user (104) accesses it again. This relieves the user (104) from having to revisit the object (120-2) again or memorizing the clipped virtual content (126). As such, the user (104) may access the saved clipped virtual content (126) via the user desktop client (127) and send and receive commands (128) to and from the repository server (103) to curate, organize, and share the clipped virtual content (126) with others.

Additionally, the repository server (103) may provide publication information (129) to the publisher (123) via the image server (102) and publisher interface (124). The publication information (129) may comprise various information regarding how, why, and with whom a publisher's (123) published virtual content (119) is being clipped and shared. For example, a publisher (123), using the publication information (129), may be able to better target a group of people in a geographical area with advertising using this information (129). If the publication information (129) shows that a certain demographic of people are not accessing the virtual content (119), then the publisher (123) may take specific action so that their message is received by that demographic. Additionally, if the publication information (129) indicates that specific portions of the virtual content (119) is being utilized, the publisher (123) may direct other types of virtual content (119) to be uploaded to the image server (102) so as to take further advantage of social trends.

In one example, an operator of the image server (102) and/or repository server (103) may charge a subscription fee to the publisher (123) for adding and/or manipulating virtual packages (125) and/or accessing any publication information (129). In this example, the image server (102) and repository server (103) may be provided to the publisher (123) on a cloud network as a storage as a service (STaaS) and software as a service (SaaS) cloud computing environment. In another example, the repository server (103) may provide the publisher (123) with access to publication information (129) on a software as a service (SaaS) cloud computing environment.

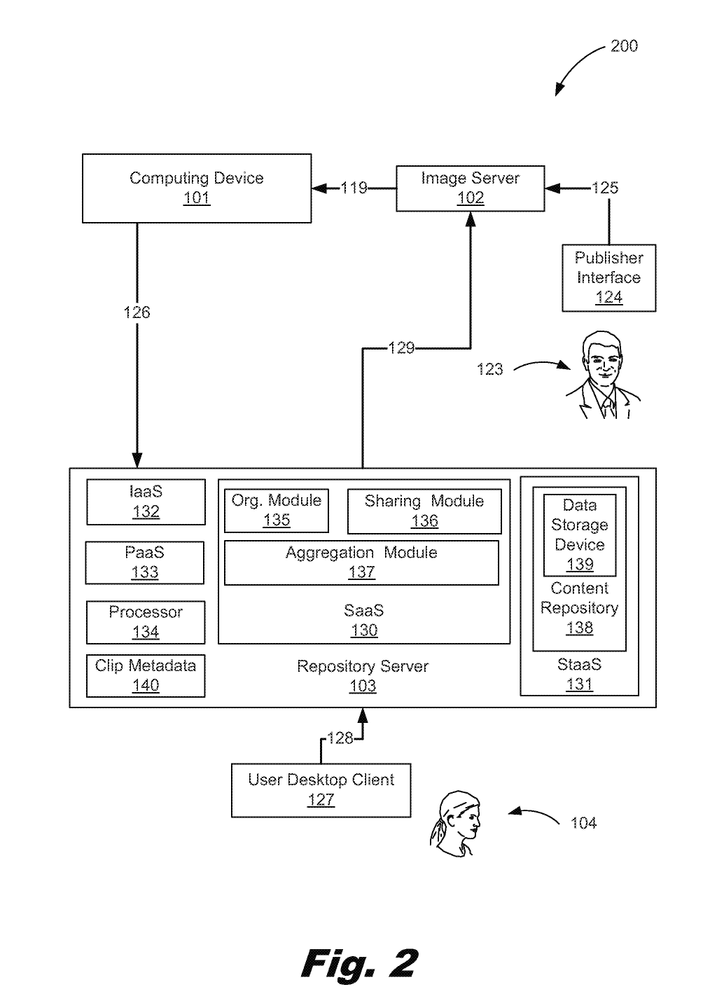

Looking now at FIG. 2, a block diagram of an augmented reality tag clipper system (200) is shown according to another example of principles described herein. As described above, the repository server (103) may comprise a hybrid cloud computing environment that provides software as a service (SaaS) (130) and storage as a service (StaaS) (131). The repository server (103) may further provide infrastructure as a service (IaaS) (132) and platform as a service (PaaS) (133) functionality as well.

In offering software as a service (130) the repository server (103) may include a number of computer code components defining computer readable code to allow a user (104) to save, manipulate and share any clipped virtual content (126). Specifically, the repository server (103) may comprise an organization module (135), an aggregation module (137), and a sharing module (136) which organizes, aggregates, and shares clipped virtual content (126) for a number of users (104). The aggregation module (137) may allow a user (104) to collect clipped virtual content (126) received from the computing device (101). In one example, the aggregation module (137) may cause clipped virtual content (126) to be saved to a content repository (138). The clipped virtual content (126) may be stored on a data storage device (139) within the content repository (138). The data storage device (139) may include, for example, Random Access Memory (RAM), Read Only Memory (ROM), Hard Disk Drive (HDD) memory, and flash memory. Many other types of data storage devices (106) are available, and the present specification contemplates the use of any type of data storage device (106) as may suit a particular application of the principles described herein.

The organization module (135), when executed by a processor (134), allows a user (104) to, through the user desktop client (127), organize clipped virtual content (126) as they see fit. For example, the user may edit or delete clipped virtual content (126). Still further, the user may organize the clips geographically on a mapping system, place the clipped virtual content (126) chronologically in a timeline, or otherwise organize the clipped virtual content (126) in a manner suitable to the user (104). Even further, the organization module (135) may allow the user to associate the object (120-2) with the virtual content (119) which was received by the computing device (101) as a trigger when the image was captured. In this case, the image may be associated with the clipped virtual content (126) on the repository server (103). In one example, the user (104) may organize clipped virtual content (126) based on whether or not an image has been or should be associated with each clipped virtual content (126). The user (104) may utilize the information provided to the repository server (103) by either the computing device (101) or image server (102) to associate the image with the clipped virtual content (126) should the image not exist.

The sharing module (136), when executed by the processor (134), allows a user to share the clipped virtual content (126) directly with another user to publish the clipped virtual content (126) on their social networking sites. Once shared, a user (104) may comment on certain aspects of the clipped virtual content (126).

What clipped virtual content (126) the user (104) clips, how the user (104) organizes the clipped virtual content (126), and how the user (104) shares the clipped virtual content (126) with other users may all be kept by the repository server (103) as clip metadata (140). This clip metadata (140) may be, with the processor (134), organized and provided to the publisher (123) as publication information (129) as described above. In one example, the publisher interface (124) may directly interface with the repository server (103) so as to provide a publisher (123) with the publication information (129). In another example, a publisher (123) may be presented with the publication information (129) through the image server (102) when the publisher (123) accesses the image server (102) to add, edit or delete virtual content (119) stored thereon. In yet another example, the image server (102) and repository server (103) a together part of a cloud network to which a publisher (123) may access the publication information (129).

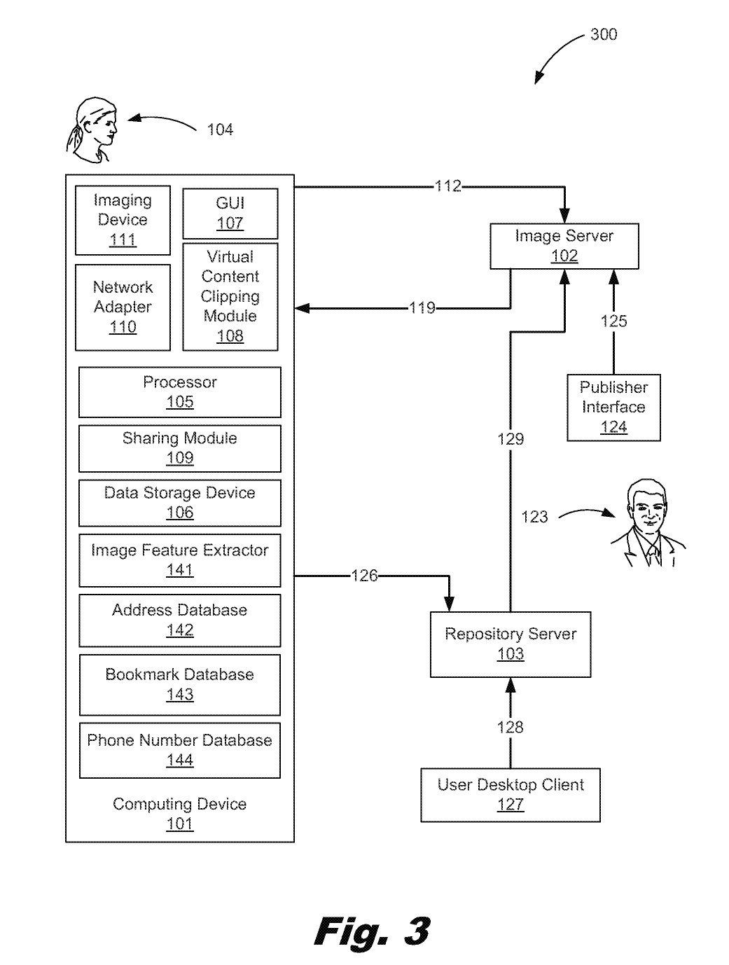

Turning now to FIG. 3, a block diagram of an augmented reality tag clipper system (300) is shown according to another example of principles described herein. FIG. 3 shows additional features of the computing device (101) and the relation of those features to the image server (102) and repository server (103). Specifically, the computing device (101) may further comprise an image feature extractor (141), an address database (142), a bookmark database (143), and a phone number database (144). These will now be described in more detail.

The image feature extractor (141), with the help of the processor (105), receives an image from the imaging device (111) and extracts the features within the image. In one example, the image feature extractor (141) may use Structured Binary Intensity Patterns (sBIP) present in the image to extract the features of the image. Other processes may also be employed which extract features within an image and the present specification contemplates their use. After the image feature extractor (141) has extracted the features from the image, the processor may cause the data defining the features in the image (112) to the image server (102) for processing as described above.

The address database (142), bookmark database (143), and phone number database (144) may all be used to store addresses, bookmarks, and phone numbers respectively. In one example, after the computing device (101) has received the virtual content (119) from the image server (102), the user may wish to save a portion of any information in the virtual content (119) on their databases (142, 143, 144). In one example, the virtual content (119) may comprise a phone number which the user (104) may wish to save for later use. In this case, the user (104) may use the content clipping module (108), GUI (107) and processor (105) to clip that phone number from the virtual content (119) and cause the phone number to be saved in the phone number database. Similarly, if the virtual content (119) comprises a data defining an Internet uniform resource locator (URL) or a address (i.e., IP address or physical address) the user (104) may also be given the option to save that data to the bookmark database (143) and address database (142) respectively.

Additionally, as described above, any saved address, phone number, or bookmark may be shared to other users using the sharing module (109). In one example, the user (104) may be given an option via the GUI (107) to share the information directly with another user of another computing device. In another example, the user (104) may be given the option to send the address, bookmark, or phone number as clipped virtual content (126) to the repository server (103) for later use and sharing.

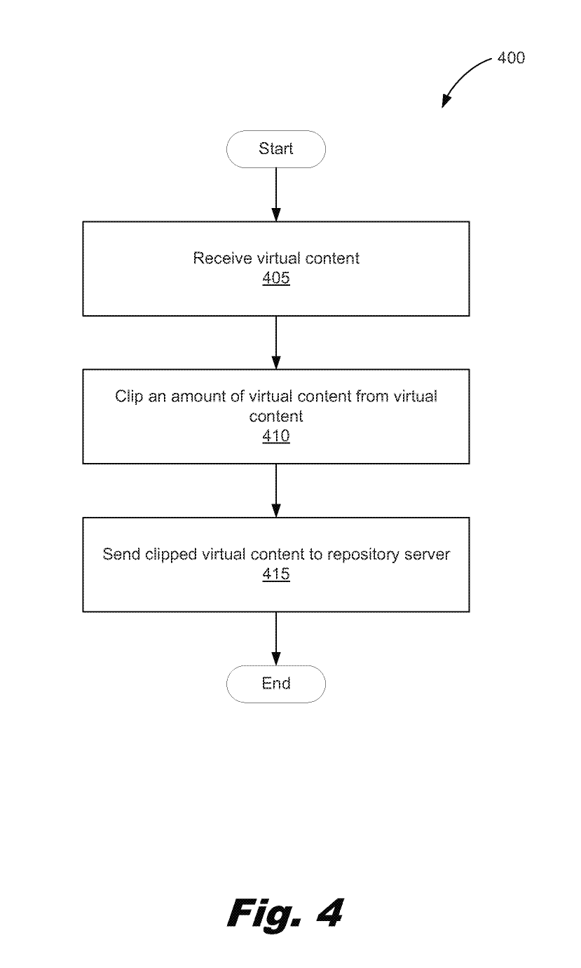

FIG. 4 is a flowchart showing a method (400) of clipping virtual content (119) according to one example of principles described herein. The method may begin with a computing device (101) receiving (405) virtual content from an image server (102). The computing device (101), as described above, may receive instructions to clip (410) an amount of virtual content (119) from the virtual content (119) received from the image server (102). Again, the amount of virtual content (119) dipped (410) from the virtual content (119) received by the computing device (101) from the image server (102) may be all or a portion of the virtual content (119). Once the virtual content (119) has been clipped (410), the computing device (101) may send (415) the clipped virtual content (126) to a repository server.

The specification and figures describe an augmented reality tag clipper system and method of clipping virtual content. The system includes a virtual content clipping module on a computing device which receives virtual content and allows a user to clip that content. Once clipped, the user may advantageously share or store the clipped virtual content. This allows a user to keep information such as URL's, IP addresses, physical addressed, phone numbers and virtual content the user deems to be of value for later use. Additionally, the computing device contains a sharing module which allows a user to share the clipped virtual content with others operating a computing device. Still further the clipped virtual content may be sent to a repository server by the user using the computing device so that the user may organize and share the virtual content from the repository server. Even further, the system allows publisher's of virtual content to be made aware of how any user of a computing device clips and shares their published virtual content.

The preceding description has been presented to illustrate and describe examples of the principles described. This description is not intended to be exhaustive or to limit these principles to any precise form disclosed. Many modifications and variations are possible in light of the above teaching.

What is claimed is:

1. An augmented reality tag clipper system, comprising:
a computing device comprising a processor and a data storage device;
an image server communicatively coupled to the computing device; and
a repository server communicatively coupled to the computing device and image server;
in which the computing device comprises a virtual content cupping module which receives virtual content associated with an object in a digital image, receives instructions to clip the virtual content, and causes the clipped virtual content to be sent to the repository server.

2. The augmented reality tag clipper system of claim 1, in which the computing device is a mobile device and in which the mobile device sends data defining features of a digital image to the image server.

3. The augmented reality tag clipper system of claim 2, in which the image server matches the data defining features of a digital image with an image stored on the image server and sends virtual content associated with the image stored on the image server to the computing device.

4. The augmented reality tag clipper system of claim 1, in which the computing device further comprises a sharing module which causes the clipped virtual content to be shared with a number of computing devices.

5. The augmented reality tag clipper system of claim 1, in which the repository server further comprises an organization module to organize clipped virtual content.

6. The augmented reality tag clipper system of claim 1, in which the repository server further comprises a sharing module to, when executed by a processor, share the clipped virtual content (126) with a number of computing devices.

7. The augmented reality tag clipper system of claim 1, further comprising a publisher interface through which a publisher of virtual content uploads, edits, and deletes virtual content to, on and from the image server.

8. The augmented reality tag clipper system of claim 7, in which the publisher interface further provides information regarding how, why, and with whom a publisher's virtual content is being clipped and used.

9. A computing device, comprising:
a virtual content clipping module which, with a processor, clips an amount of virtual content from virtual content received by the computing device.

10. The computing device of claim 9, further comprising a sharing module to send the clipped amount of virtual content to another computing device.

11. The computing device of claim 9, further comprising:
an imaging device to capture a digital image of an object;
an image feature extractor to extract features present in the image from the image; and
a network adapter to send data defining the extract features present in the image to an image server.

12. The computing device of claim 10, in which the computing device receives the virtual content from the image server.

13. A method of clipping virtual content, comprising
with a processor, receiving virtual content from an image server on a computing device;
capping an amount of virtual content from the virtual content; and
sending clipped virtual content to a repository server.

14. The method of claim 13, further comprising:
before receiving virtual content from an image server:
capturing an image of an object;
with a processor, extracting features present in the image from the image; and
sending data defining the extract features present in the image to an image server.

15. The method of claim 13, in which clipping an amount of virtual content from the virtual content further comprises saving the clipped virtual content in an address database, a bookmark database, a phone number database or a combination of these.
